(19) United States
(12) Patent Application Publication
(10) Pub. No.: US 2020/0239152 A1
(43) Pub. Date: Jul. 30, 2020

(54) THERMAL MANAGEMENT SYSTEM

(71) Applicant: Bell Helicopter Textron Inc., Fort Worth, TX (US)

(72) Inventor: Joseph Dean Rainville, Fort Worth, TX (US)

(73) Assignee: Bell Helicopter Textron Inc., Fort Worth, TX (US)

(21) Appl. No.: 16/262,059

(22) Filed: Jan. 30, 2019

(51) Int. Cl. B64D 33/08; H01M 8/04007; B64C 27/28; B64C 27/20; B64C 27/26

(52) U.S. Cl. CPC B64D 33/08; H01M 8/04074; B64C 27/28; B64C 29/0016; B64C 27/26; H01M 2250/20; B64C 27/20

(57) ABSTRACT

A thermal management system includes a plurality of passages through a leading edge of a component of an aircraft. The thermal management system is configured to circulate coolant from a heat source through the plurality of passages in order to maximize heat transfer from the coolant to the airflow passing over the leading edge.

### BACKGROUND

The use of hydrogen fuel cells is being explored for powering both manned and unmanned aircraft. Fuel cells operate by facilitating an electrochemical reaction between hydrogen and oxygen, which produces electricity, water, and heat. Different types of fuel cells have different optimal operating temperature ranges and deviation from those optimal temperature ranges can result in decreased efficiency of the fuel cell. As such, it is important to maintain the fuel cell within the optimal temperature range.

Fuel cells typically utilize a finned tube, or plate tube, type heat exchanger that circulates a coolant through the fuel cell stack, drawing heat from the fuel cells and then passing the coolant through a serpentine pipe passing back and forth through a plurality of fins or plates. The fins serve to increase the surface area of the serpentine pipe to increase the thermal conduction from the pipe to the surrounding air.

### BRIEF DESCRIPTION OF THE DRAWINGS

FIG. 1 is an oblique view of an aircraft including a ducted fan thermal management system, according to this disclosure, shown with the ducted fans transitioning between a helicopter mode and an airplane mode.

FIG. 2 is a front view of the aircraft of FIG. 1, shown with the ducted fans in the helicopter mode.

FIG. 3 is a top view of the aircraft of FIG. 1, shown with the ducted fans in the helicopter mode.

FIG. 4 is an oblique view of one of the ducted fans of the aircraft of FIG. 1.

FIG. 5 is a top view of the aircraft of FIG. 1, showing internal components of the thermal management system.

FIG. 6 is a is a cross-sectional view of a stator vane of the ducted fan of FIG. 4.

FIG. 7 is a cross-sectional oblique view of a leading end of the stator vane of FIG. 6, showing a possible coolant path.

### DETAILED DESCRIPTION

While the making and using of various embodiments of this disclosure are discussed in detail below, it should be appreciated that this disclosure provides many applicable inventive concepts, which can be embodied in a wide variety of specific contexts. The specific embodiments discussed herein are merely illustrative and do not limit the scope of this disclosure. In the interest of clarity, not all features of an actual implementation may be described in this disclosure. It will of course be appreciated that in the development of any such actual embodiment, numerous implementation-specific decisions must be made to achieve the developer's specific goals, such as compliance with system-related and business-related constraints, which will vary from one implementation to another.

In this disclosure, reference may be made to the spatial relationships between various components and to the spatial orientation of various aspects of components as the devices are depicted in the attached drawings. However, as will be recognized by those skilled in the art after a complete reading of this disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction. In addition, the use of the term “coupled” throughout this disclosure may mean directly or indirectly connected, moreover, “coupled” may also mean permanently or removably connected, unless otherwise stated.

Typically, a fuel cell generates approximately 1 kW of waste heat per 1 kW of electricity generated. Accordingly, if an aircraft relies on a fuel cell for powering its propulsion system, the aircraft must be able to eliminate a large amount of waste heat. Compared to a rotary-wing aircraft, a fixed-wing aircraft requires significantly less power to maintain flight, and the constant forward motion of a fixed-wing aircraft provides an airflow that may be utilized to dissipate the waste heat generated by the fuel cell, for example, through the use of a ram air intake to channel air toward a conventional heat exchanger. However, a rotary-wing aircraft uses substantially more power to hover, therefore producing substantially more waste heat, without the benefit of airflow provide by movement of the aircraft. The thermal management system divulged herein provides for heat dissipation for a fixed-wing aircraft without the added mass of a conventional heat exchanger or a drag inducing ram air intake and provides for heat dissipation for a rotary-wing aircraft while hovering.

This disclosure divulges a thermal management system utilizing coolant passages formed in leading edges of an aircraft for heat dissipation. It further divulges a fuel cell powered aircraft utilizing tilting ducted fans for generating lift and thrust, wherein the ducted fans are configured to dissipate heat generated by the fuel cell. Placing a fan inside a properly designed duct may increase the amount of lift/thrust produced by the ducted fan arrangement compared to a fan without a duct. This may be accomplished, at least in part, because the fan accelerates the airflow over the leading edge of the duct, thereby decreasing the pressure above the duct, while behind the fan disk, the duct diverges to decelerate the air and return it to atmospheric pressure. In addition, flow-straightening stator vanes downstream of the fan disk recover rotational energy of the airflow, generating additional axial thrust. The location of the stator vanes immediately downstream of the fan disk subjects the leading edges of the stator vanes to increased velocity airflow. Similarly, the leading edges of aircraft surfaces experience a large airflow. As such, incorporation of coolant passages in any leading edges of the aircraft may be utilized for heat dissipation.

As mentioned above, the thermal management system divulged herein may reduce the overall mass of an aircraft by downsizing or eliminating the need for a conventional heat exchanger. And by incorporating the elements of the thermal management system into the preferred shapes of the aircraft components, it may reduce the overall mass without increasing the drag of the aircraft.

While the thermal management system described herein focuses on utilizing the leading edges of aircraft structures, because the airflow at those locations maximizes the potential heat transfer, the system may be utilized by incorporating coolant passages on any exterior surface of an aircraft. Moreover, while this disclosure focuses on utilizing the thermal management system for the dissipation of heat generated by a fuel cell, the thermal management system disclosed herein may be used with any heat source on an aircraft, such as an internal combustion engine, etc. Moreover, the thermal management system may include features that make functional usage of the waste heat. For example, the thermal management system may direct heated coolant through passages in a passenger compartment of the aircraft to maintain a comfortable cabin temperature.

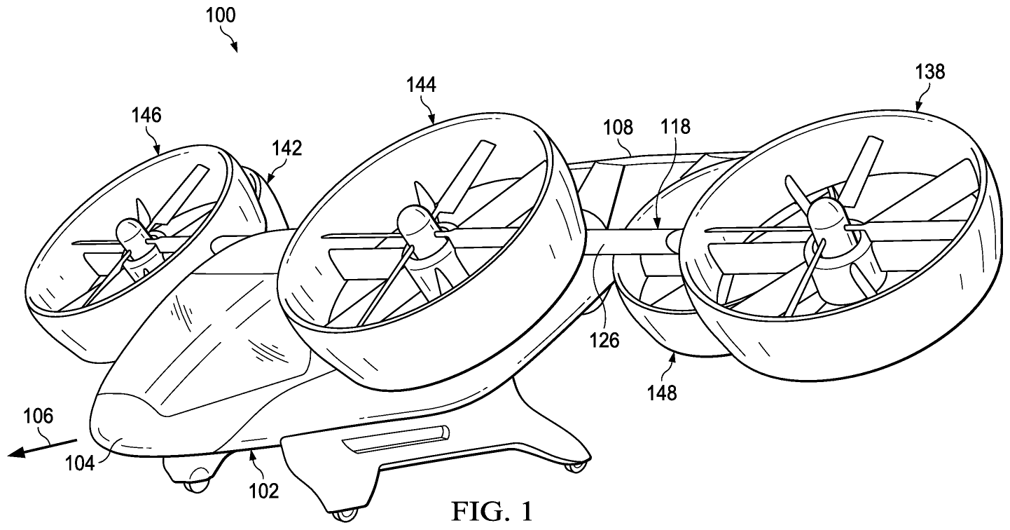

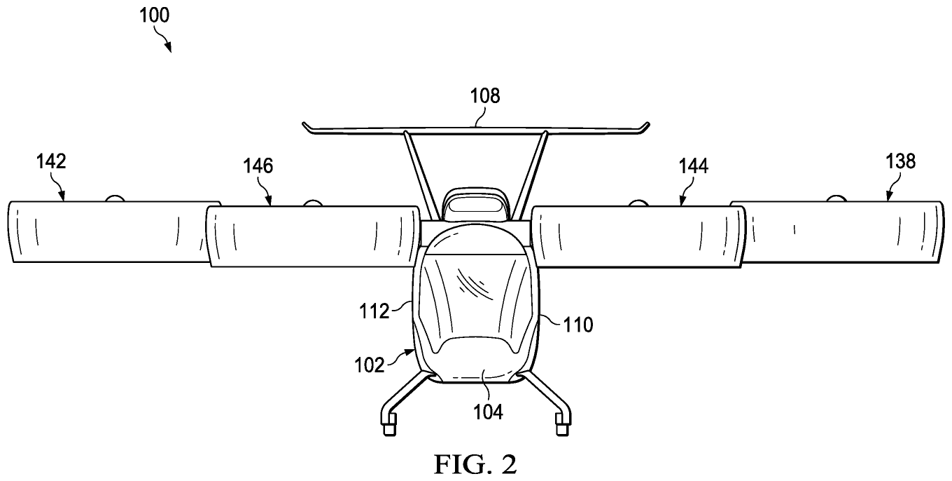

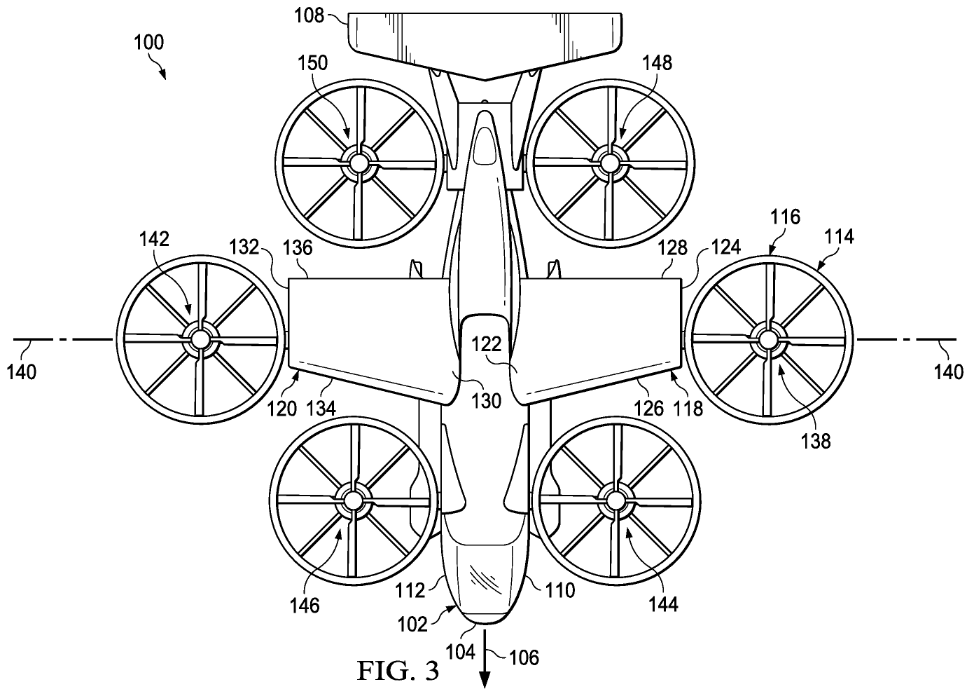

FIGS. 1-3 show an aircraft 100 that is convertible between a helicopter mode, which allows for vertical takeoff and landing, hovering, and low speed directional movement, and an airplane mode, which allows for forward flight as well as horizontal takeoff and landing. Aircraft 100 includes a fuselage 102 having a nose section 104 facing a primary direction of travel 106, a tail section 108, a first side 110, and a second side 112; a propulsion system 114 for providing lift and/or thrust; and a thermal management system 116 for dissipating heat from a heat source, such as a power generating device. Lift of aircraft 100, when in airplane mode, is provided by a first wing 118 extending from first side 110 of fuselage 102 and a second wing 120 extending from second side 112 of fuselage 102. First wing 118 includes a proximal end 122 adjacent fuselage 102, an opposite distal end 124, a leading portion 126 facing primary direction of travel 106, and an opposite trailing portion 128. Second wing 120 similarly includes a proximal end 130 adjacent fuselage 102, an opposite distal end 132, a leading portion 134 facing primary direction of travel 106, and an opposite trailing portion 136. First wing 118, second wing 120, and tail section 108 include flight control surfaces (not show) for controlling the attitude of aircraft 100 while operating in airplane mode.

Propulsion system 114 includes a first ducted fan 138 rotatably coupled to distal end 124 of first wing 118, via a spindle 139, about a tilt axis 140 and a second ducted fan 142 rotatably coupled to distal end 132 of second wing 120 about tilt axis 140. Propulsion system 114 further includes a third ducted fan 144, and a fourth ducted fan 146, rotatably coupled to first side 110 and second side 112 of fuselage 102 proximate nose section 104, respectively. Propulsion system 114 also includes and a fifth ducted fan 148, and a sixth ducted fan 150, rotatably coupled to first side 110 and second side 112 of tail section 108, respectively.

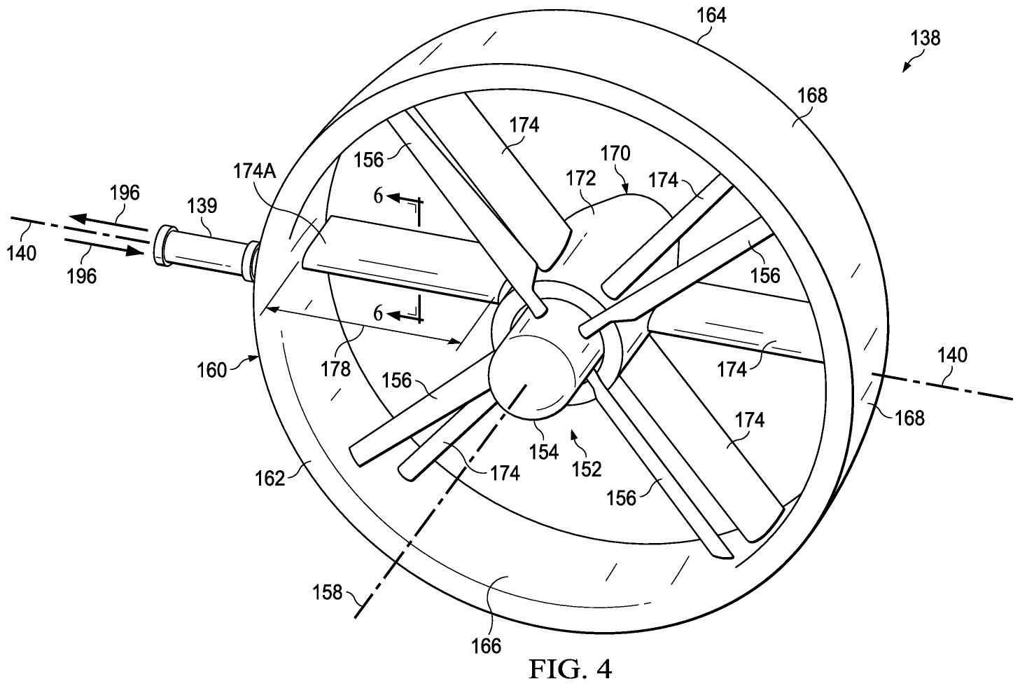

As best shown in FIG. 4, first ducted fan 138 (as well as second, third, fourth, fifth, and sixth ducted fans 142, 144, 146, 148, and 150) includes a fan 152 including a fan hub 154 and a plurality of fan blades 156 extending radially from fan hub 154, and coupled thereto for common rotation about a rotation axis 158. Rotation of plurality of fan blades 156 about rotation axis 158 generates lift while operating in helicopter mode and thrust while operating in airplane mode. Plurality of fan blades 156 are rotatably coupled to fan hub 154 about their pitch change axes to allow for cyclic and collective pitch control of plurality of fan blades 156, thereby enabling directional movement of aircraft 100 while operating in helicopter mode. Fan 152 is surrounded by a duct 160 that includes a first end 162, a second end 164, an interior wall 166 extending from first end 162 to second end 164, and an exterior wall 168 extending from first end 162 to second end 164. A flow straightening stator assembly 170 is positioned downstream of fan 152. Stator assembly 170 includes a stator hub 172 centrally located within duct 160 and a plurality of stator vanes 174 coupled between interior wall 166 of duct 160 and stator hub 172.

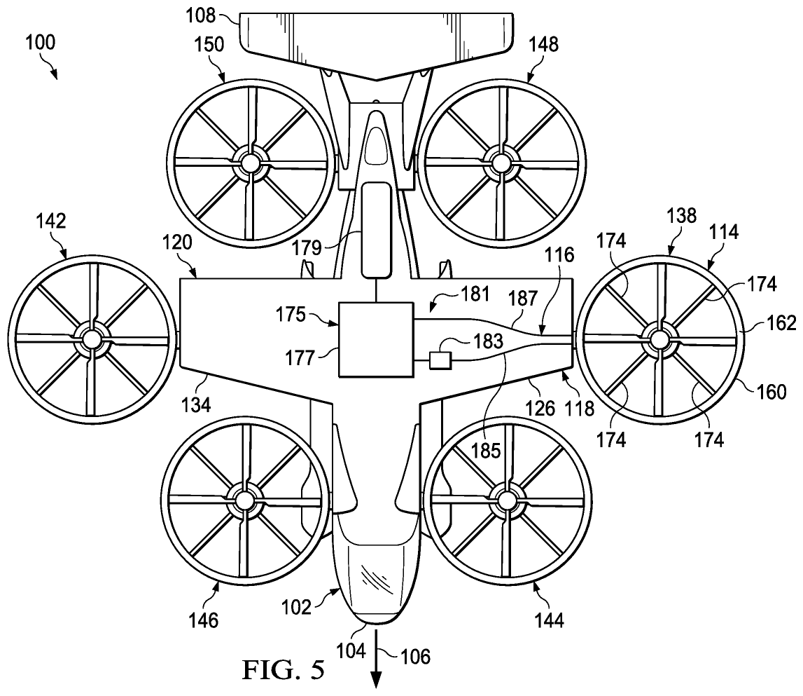

Fan 152 is driven in rotation about rotation axis 158 by an electric motor (not shown) housed within stator hub 172. As shown in FIG. 5, electricity for powering the electric motor is generated by a fuel cell system 175 housed within fuselage 102. Fuel cell system 175 may comprise one large fuel cell 177, and a hydrogen fuel supply 179, for providing all the electricity required by aircraft 100. Alternatively, fuel cell system 175 may comprise one fuel cell for each of ducted fans 138, 142, 144, 146, 148, and 150, and include redundant wiring to permit each of the fuel cells to provide electricity to any or all of ducted fans 138, 142, 144, 146, 148, and 150. It should be understood that fuel cell 177 may comprise a fuel cell stack including a plurality of fuel cells. Fuel cell 177 may comprise a polymer exchange membrane fuel cell or any other type of fuel cell suitable for use on an aircraft. During operation, in addition to generating electricity and waste heat, fuel cell 177 produces water. The water may be disposed of by simply allowing it to drain through a port in a bottom of fuselage 102. Alternatively, the water may be stored in a tank for future use, such as in a fire suppression system.

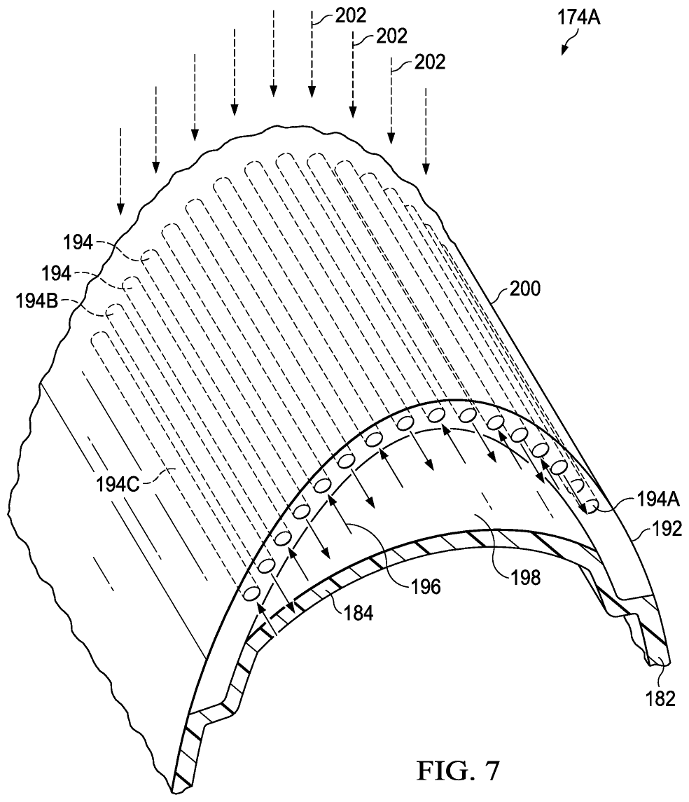

Still referring to FIG. 5, the waste heat generated by fuel cell 177 is dissipated by thermal management system 116. Thermal management system 116 includes one or more passages configured to transmit a coolant 196 (schematically illustrated in FIGS. 4 and 7) therethrough. Preferably, the passages extend along at least one leading edge of aircraft 100, wherein the at least one leading edge is a forward-facing surface in primary direction of travel 106 and/or a front surface of a component in an airflow path generated by propulsion system 114. A detailed example of the passages extending along a leading edge of aircraft is discussed below in reference to stator vanes 174. Coolant 196 is passed through fuel cell 177 where it absorbs the waste heat therefrom. Coolant 196 is then circulated from fuel cell 177 through a closed loop system 181 by a pump 183 housed within fuselage 102. It should be understood that while pump 183 is illustrated as being remote from fuel cell 177, it may be integrated therein. Closed loop system 181 includes a first channel 185 coupled between fuel cell 177 and a first passage of the passages located on any leading edge of aircraft 100, first channel 185 is configured to transmit hot coolant 196 from fuel cell 177 to the first passage. Closed loop system 181 also includes a second channel 187 coupled between a final passage of the passages located on any leading edge of aircraft 100, second channel 187 being configured to return cool coolant 196 from the final passage to fuel cell 177.

As mentioned above, the passages of thermal management system 116 may include passages located on any leading edge of aircraft 100, such as one or more conduits traversing a cover comprising first end 162 of duct 160, nose section 104 of fuselage 102, leading portion 126 of first wing 118, leading portion 134 of second wing 120, and/or any other leading edge of aircraft 100. However, for simplicity, the plurality of passages of thermal management system 116 are described herein with respect to a first stator vane 174A of plurality of stator vanes 174, with the understanding that the structure shown on, and discussed with reference to, first stator vane 174A may be modified and utilized on any leading surface of aircraft 100. Moreover, while FIG. 5 only shows closed loop system 181 circulating coolant 196 between fuel cell 177 and first ducted fan 138, it should be understood that closed loop system 181 may circulate coolant 196 through ducted fans 142, 144, 146, 148, and 150 as well. Alternatively, thermal management system 116 may comprise a plurality of closed loop systems 181, each circulating between fuel cell 177 and one of ducted fans 138, 142, 144, 146, 148, and 150. In addition, closed loop system 181 may include any or all passages located on leading edges of aircraft 100.

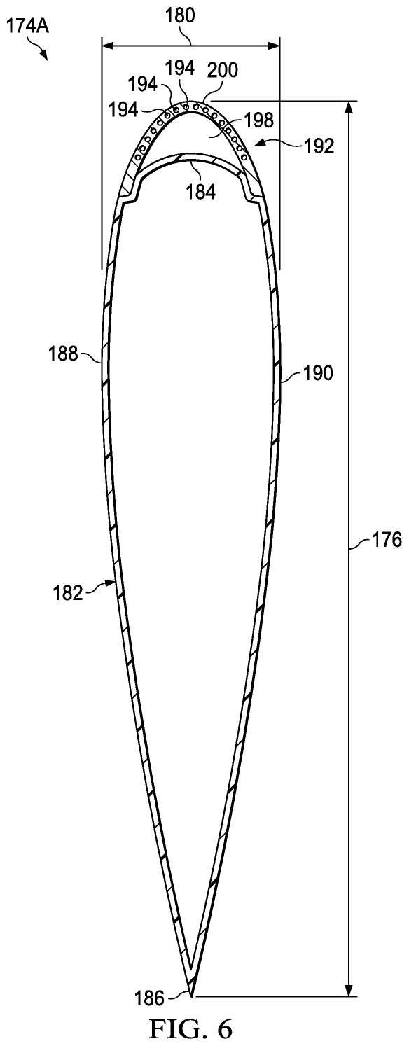

Referring now to FIGS. 4-7, thermal management system 116, utilizing plurality of stator vanes 174, is shown. First stator vane 174A, representative of each of plurality of stator vanes 174, has a chordwise length 176, a spanwise width 178, and a depth 180 perpendicular to chordwise length 176 and spanwise width 178. First stator vane 174A includes a body 182 that has a leading end 184, a trailing end 186, a first sidewall 188 extending from leading end 184 to trailing end 186, and a second sidewall 190 extending from leading end 184 to trailing end 186. An abrasion strip 192 is coupled to leading end 184 of body 182 such that abrasion strip 192 forms a continuous surface with first sidewall 188 and second sidewall 190. Abrasion strip 192 includes a plurality of passages 194 extending along at least a portion of spanwise width 178 of first stator vane 174A, wherein plurality of passages 194 are configured to transmit coolant 196 therethrough.

For weight savings, body 182 may preferably be made of a composite material, such as carbon fiber, fiberglass, etc., and abrasion strip 192 may preferably be made of a metal, such as aluminum, stainless steel, etc. Abrasion strip 192 may preferably be made of metal because it must to be able to withstand high temperatures transferred thereto by coolant 196. Because composite materials may be damaged by exposure to high temperatures, first stator vane 174A includes a void 198 between body 182 and abrasion strip 192 along the portion of spanwise width 178 that passages 194 extend, which may include the entirety of spanwise width 178. Void 198 is filled with air (or may be a vacuum) and serves to insulate leading end 184 of body 182 from the heat dissipating from coolant 196 passing through plurality of passages 194. Alternatively, body 182 and abrasion strip 192 may both be made of a metal. Additionally, first stator vane 174A may comprise a single unibody structure wherein abrasion strip 192 and body 182 are one piece made of a metal.

FIG. 7 shows a portion of first stator vane 174A, illustrating a possible path of coolant 196 through plurality of passages 194. In FIG. 7, hot coolant 196 is transmitted to a first passage 194A via first channel 185 coupled between fuel cell 177 and first passage 194A through spindle 139. Adjacent passages 194 are connected via U-shaped sections alternately located proximate stator hub 172 and interior wall 166 of duct 160 such that coolant 196 flows a first direction down first passage 194A toward stator hub 172 then a second direction toward interior wall 166 and back again until it reaches a penultimate passage 194B. From penultimate passage 194B, coolant 196 passes through a conduit in stator hub 172 to a first channel in adjacent abrasion strip 192, and the pattern continues through each abrasion strip 192 of plurality of stator vanes 174 until coolant 196 returns through a final passage 194C to second channel 187 through spindle 139 and back to fuel cell 177. Alternative coolant 196 paths will be readily recognized by those skilled in the art and are therefore considered to be within the scope of this disclosure. For example, because it is desirable to keep heat away from the composite material of body 182, it may be beneficial to first direct coolant 196 back and forth through only the centermost passages 194 of each abrasion strip 192 of plurality of stator vanes 174 to allow the temperature of coolant 196 to decrease before directing it down passages 194 adjacent first sidewall 188 and second sidewall 190. Alternatively, first channel 185 may be coupled to a first half of plurality of passages 194 such that coolant 196 flows in parallel down the first half of plurality of passages 194; then passes through conduits in stator hub 172 to a first half of plurality of passages 194 of adjacent stator vane 174; flows to an and of abrasion strip 194 where the first half of the plurality of passages 194 are connected via U-shaped sections to a second half of the plurality of passages; flows to stator hub 172 and threw conduits to a first half of plurality of stator vanes of next adjacent stator vane 194; and the pattern follows until coolant 196 reaches second channel 187. In addition, it may be advantageous to direct coolant 196 through additional passages on other leading edges of aircraft 100 before and/or after passages 194 of each abrasion strip 192 of plurality of stator vanes 174. While abrasion strip 192 is shown with a smooth outer surface 200, it should be understood that the area of outer surface 200 may be increased for additional heat transfer by including a plurality of fins (not shown) extending therefrom and/or a plurality of grooves (not shown) recessed therein. The fins and/or grooves should be oriented in a generally perpendicular configuration with respect to the flow of coolant 196 through plurality of passages 194, such that when an airflow 202 contacts outer surface 200, it flows lengthwise along the fins and/or grooves from a point of contact towards trailing end 186.

At least one embodiment is disclosed, and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 95 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C.

What is claimed is:

1. A thermal management system, comprising:
a stator vane having a chordwise length, a spanwise width, and a depth perpendicular to the chordwise length and the spanwise width, the stator vane comprising:
a body having a leading end, a trailing end, a first sidewall extending from the leading end to the trailing end, and a second sidewall extending from the leading end to the trailing end; and
an abrasion strip coupled to the leading end of the body, the abrasion strip including at least one passage extending along at least a portion of the spanwise width of the stator vane, wherein the at least one passage is configured to transmit a coolant therethrough.

2. The thermal management system of claim 1, wherein the stator vane includes a void between the body and the abrasion strip along the portion of the spanwise width that the at least one passage extends.

3. The thermal management system of claim 2, wherein the body comprises a composite material and the abrasion strip comprises a metal.

4. The thermal management system of claim 3, further comprising:
a duct having a first end, a second end, and an interior wall extending from the first end to the second end; and
a stator hub positioned centrally within the duct;
wherein the stator vane is coupled between the interior wall of the duct and the stator hub.

5. The thermal management system of claim 4, further comprising:
a fan rotatably coupled to the stator hub; and
a pump configured to circulate the coolant from a heat source through the at least one passage of the abrasion strip.

6. The thermal management system of claim 5, wherein the heat source is a fuel cell.

7. The thermal management system of claim 6, wherein the first end of the duct includes a cover having at least one conduit configured to transmit the coolant therethrough.

8. A thermal management system, comprising:
a fan, comprising:
a fan hub; and
a plurality of fan blades extending from the fan hub;
wherein the fan hub and the plurality of fan blades are coupled for common rotation about a rotation axis;
a duct surrounding the fan, the duct having a first end, a second end, and an interior wall extending from the first end to the second end;
a stator hub centrally located within the duct, the fan being rotatably coupled to the stator hub; and
a plurality of stator vanes coupled between the interior wall of the duct and the stator hub, each of the plurality of stator vanes having a chordwise length, a spanwise width, and a depth perpendicular to the chordwise length and the spanwise width, each of the plurality of stator vanes, comprising:
a body having a leading end, a trailing end, a first sidewall extending from the leading end to the trailing end, and a second sidewall extending from the leading end to the trailing end; and
an abrasion strip coupled to the leading end of the body, the abrasion strip including a first passage extending along at least a portion of the spanwise width of the stator vane and a final passage extending along the portion of the spanwise width of the stator vane, wherein the first passage and the final passage are configured to transmit coolant therethrough.

9. The thermal management system of claim 8, further comprising:
a fuel cell;
a first channel coupled between the fuel cell and the first passage of a first stator vane of the plurality of stator vanes;
a second channel coupled between the fuel cell and the final passage of the first stator vane of the plurality of stator vanes; and
a pump configured to circulate the coolant from the fuel cell through the first channel, the first passage of each of the plurality of stator vanes, the final passage of each of the plurality of stator vanes, and the second channel.

10. The thermal management system of claim 9, wherein the abrasion strip of each of the plurality of stator vanes further comprises a plurality of additional passages between the first passage and the final passage, wherein at least two adjacent passages of the plurality of additional passages are in communication with each other proximate one end of the spanwise width of the stator vane.

11. The thermal management system of claim 9, wherein each of the abrasion strips of the plurality of stator vanes further includes a plurality of additional passages extending along the portion of the spanwise width of the stator vane, wherein the first passage and a first quantity of the plurality of additional passages are configured to carry the coolant in a first direction along the spanwise width and the final passage and a second quantity of the plurality of additional passages are configured to carry the coolant in a second direction along the spanwise width.

12. The thermal management system of claim 9, wherein each of the plurality of stator vanes includes a void between the body and the abrasion strip along the portion of the spanwise width that the first passage and the final passage extend.

13. The thermal management system of claim 12, wherein the body of each of the plurality of stator vanes comprises a composite material and the abrasion strip of each of the plurality of stator vanes comprises a metal.

14. The thermal management system of claim 9, wherein the duct includes at least one conduit configured to transmit the coolant therethrough.

15. An aircraft, comprising:
a fuselage including a nose section and a tail section;
a propulsion system for generating lift and/or thrust;
a power generating device; and
a thermal management system, comprising:
a plurality of passages extending along at least one leading edge of the aircraft, wherein the at least one leading edge is a forward-facing surface in a primary direction of travel of the aircraft and/or a front surface of a component in an airflow path generated by the propulsion system; and
a pump configured to circulate coolant from the power generating device through the plurality of passages.

16. The aircraft of claim 15, wherein the power generating device comprises a fuel cell.

17. The aircraft of claim 16, wherein the propulsion system includes a first ducted fan, comprising:
a fan, comprising:
a fan hub; and
a plurality of fan blades extending from the fan hub;
wherein the fan hub and the plurality of fan blades are coupled for common rotation about a rotation axis;
a duct surrounding the fan, the duct having a first end, a second end, and an interior wall extending from the first end to the second end;
a stator hub centrally located within the duct, the fan being rotatably coupled to the stator hub;
an electric motor configured to drive the fan hub in rotation about the rotation axis; and
a plurality of stator vanes coupled between the interior wall of the duct and the stator hub, each of the plurality of stator vanes having a spanwise width, a leading end, a trailing end, a first sidewall extending from the leading end to the trailing end, and a second sidewall extending from the leading end to the trailing end.

18. The aircraft of claim 17, further comprising:
a first wing extending from a first side of the fuselage;
a second wing extending from a second side of the fuselage, wherein each of the first wing and the second wing have a proximal end adjacent the fuselage, a distal end opposite the proximal end, a leading portion facing the primary direction of travel of the aircraft, and an opposite trailing portion; and
a second ducted fan similar to the first ducted fan, wherein the first ducted fan is rotatably coupled to the distal end of the first wing about a tilt axis and the second ducted fan is rotatably coupled to the distal end of the second wing about the tilt axis.

19. The aircraft of claim 18, wherein the at least one leading edge of the aircraft is the nose section of the fuselage, the first end of the duct of the first ducted fan, a first end of a second duct of the second ducted fan, the leading end of at least one of the plurality of stator vanes, the leading portion of the first wing, and/or the leading portion of the second wing.

20. The aircraft of claim 19, wherein the at least one leading edge of the aircraft comprises a metal component, wherein a structure that the metal component is coupled to is a composite material.
